(19) United States
(12) Patent Application Publication
(10) Pub. No.: US 2025/0332498 A1
(43) Pub. Date: Oct. 30, 2025

(54) PERSONAL TRANSPORTATION DEVICE

(71) Applicants: Waleed Khan, Glen Waverley (AU); Loban Matin, Glen Waverley (AU); Radek Pesina, Glen Waverley (AU)

(72) Inventors: Waleed Khan, Glen Waverley (AU); Loban Matin, Glen Waverley (AU); Radek Pesina, Glen Waverley (AU)

(73) Assignee: Waleed Khan, Glen Waverley (AU)

(21) Appl. No.: 19/190,798

(22) Filed: Apr. 28, 2025

Related U.S. Application Data
(60) Provisional application No. 63/640,228, filed on Apr. 30, 2024.

(51) Int. Cl. A63C 5/035; A63C 5/03; A63C 5/075

(52) U.S. Cl. CPC A63C 5/035; A63C 5/03; A63C 5/075

(57) ABSTRACT

The present invention discloses a personal transportation device comprising a frame structure, a board platform, and a propulsion assembly. The board platform mounted on an upper portion of the frame to support a standing rider. The propulsion assembly mounted to a lower portion of the frame comprises an axle assembly, a first wheel assembly, a second wheel assembly, an endless drive unit, a drivetrain assembly, and a suspension system. The axle assembly comprises a first axle and a second axle opposite to the first axle. Each axle comprises a pair of wheels. The endless drive unit is engaged with the wheels to rotate in response to the wheel rotation to propel the device. The drivetrain assembly coupled to the axle assembly comprising a motor assembly. Each motor transfers rotational energy to the wheels. A suspension assembly connected between the frame structure and wheels to enable multidimensional articulation and absorb vibrations.

### CROSS-REFERENCE TO RELATED APPLICATION

The present application claims the benefit of U.S. provisional application 63/640,228, filed on 30 Apr. 2024 entitled “SNOWBOARD ASSEMBLY WITH SINGLE AND DUAL BELT SYSTEMS”, the contents of which are hereby incorporated by reference.

### TECHNICAL FIELD

The present invention generally relates to snowboards. More specifically, the present invention relates to a personal transportation device having a single belt assembly or a dual belt assembly with advanced control features.

### BACKGROUND

Snowboards are single boards designed for the winter sport of snowboarding, where participants slide down snow-covered slopes with the board attached to the participant's feet. The snowboard is a blend of skateboarding, surfing, and skiing, and has evolved into a distinct and popular activity enjoyed by millions worldwide. The snowboard generally comprises a flat body constructed of a hardwood core which is sandwiched between multiple layers of fiberglass. The flat body further includes an upper surface and a rear surface. The upper surface is configured to receive feet of snowboarders and the rear surface is configured to contact with the snow surface. The rear surface of the snowboard is fitted with a thin strip of steel. The thin strip of steel allows the snowboard to dig into hard snow and ice. Further, the thin strip of steel protects the internal structure of the board. Further, the front side of the snowboard curves upwards at the tip to facilitate smoother rides over snow, particularly when encountering uneven surfaces, bumps, or crud. This design reduces the risk of the edges catching on the snow, which could cause falls. Similarly, the back side of the snowboard curves upwards at the tip to support riding backward or in a switch stance, where the rider leads with their non-dominant foot.

Further, a few patent references related to snowboarding are discussed as follows. US20040154849 of John Fodor entitled “detachable drive unit for a snowboard” discloses a detachable drive unit for a snowboard includes a low-profile drive belt assembly designed to be mounted underneath a pre-existing, conventional snowboard, and a drive motor that powers the drive belt for propulsion up snow-covered hills or over variable snow-covered terrain. The drive belt is designed to grip snow, and when driven by the motor, propels the snowboard and snowboarder up a snow-covered hill, or over snow-covered terrain.

US20080242192A of Steven J. Derrah entitled “Remote control snowboard” discloses a radio-controlled snowboard system having a steerable snowboard and an erect figurine. The erect figurine is pivotally attachable to the steerable snowboard. The steerable snowboard includes a plurality of steering edges and a steering system configured to control the movement of the snowboard by relative weight transitions relative to one of the plurality of steering edges.

However, the existing snowboards fail to enable the users to control the snowboard according to the user's preference. Further, the limitations of existing snowboards restrict the user from managing the movement of the snowboard while navigating in different snow conditions or terrain surfaces. Consequently, the limitations make the overall snowboarding experience less enjoyable or even challenging for users to maintain control and stability while descending slopes.

Therefore, there is a need for an assembly that allows users to easily control and manage the assembly while gliding over the ground. The assembly needs to enable the user to independently control and glide across different snow conditions or terrains. Additionally, the assembly needs to provide the user with the ability to steer and allow for a comfortable ride on slopes without compromising the overall snowboarding experience.

### SUMMARY

The present invention discloses a personal transportation device. The personal transportation device comprises a frame structure, a board platform, and a propulsion assembly. The frame structure comprises an upper portion and a lower portion. The board platform is mounted to the upper portion of the frame structure. The board platform is configured to support a standing rider. The propulsion assembly is mounted to the lower portion of the frame structure.

The propulsion assembly comprises an axle assembly coupled to the frame comprising a first axle and a second axle. The propulsion assembly further comprises a first wheel assembly and a second wheel assembly. The first wheel assembly comprising at least two wheels mounted at opposing ends of the first axle. The second wheel assembly comprising at least two wheels mounted at opposing ends of the second axle. The second wheel assembly being positioned opposite the first wheel assembly.

The propulsion assembly further comprises at least one endless drive unit operatively engaged with the wheels. The continuous drive unit is configured to rotate in response to the rotation of the wheels, thereby providing propulsion to the device. Further, at least one endless drive unit operatively engaged with one wheel of the first axle and the corresponding wheel of the second axle, and at least one endless drive unit operatively engaged with the other wheel of the first axle and the other corresponding wheel of the second axle. In one embodiment, the endless drive unit comprises a pair of side rails and a plurality of transverse crossbars extending between the side rails. The crossbars are configured to engage with wheels and provide ground traction during propulsion. The crossbars comprise a plurality of spaced apart wedges extending a portion of the surface of the crossbar engaging the ground. In one embodiment, the endless drive unit is configured to extend along at least a portion of the lower portion of the frame. In another embodiment, the endless drive unit is configured to extend along a length of the lower portion of the frame.

The propulsion assembly further comprises a drivetrain assembly coupled to the axle assembly comprising one or more motor assemblies. Each motor assembly is operatively coupled to one or more wheels to transfer rotational energy to the first wheel assembly and second wheel assembly. The motor assembly comprises an electric motor, wherein the wheels are gear wheels. The electric motor is coupled to the respective gear wheel through a drive system and configured to transfer torque from a respective motor shaft to the respective wheel. The drive system comprises at least one of a drive belt and gear assembly. In one embodiment, the electric motor is coupled to the respective gear wheel through a drive belt connected to a gear that is operatively connected to a wheel hub of the gear wheel.

The frame further comprises at least two side plates. The first axle and the second axle are arranged between the side plates. The propulsion assembly further comprises a suspension system coupled to the drivetrain assembly and axle assembly. The suspension system comprises one or more suspension assemblies. Each suspension assembly operatively connected between the frame and one or more wheels to allow multidimensional articulation and vibration damping. The suspension system is configured to absorb vibrations and enable three-dimensional movement of the wheel assembly relative to the frame structure.

The device further comprises a tensioning system coupled to the axle assembly. The tensioning system is configured to adjust the spacing between the first wheel assembly and second wheel assembly to control the tension of the endless drive unit. The device further comprises a lighting system configured to provide illumination and visual feedback. The lighting system comprises one or more headlights, taillights, and body lights arranged on the frame structure. The lightening system further comprises a control circuit. The control circuit is operatively connected to the system control unit. Further, the control circuit is configured to regulate the power to the lighting components and control lighting behavior based on the operating conditions of the device.

The device further comprises a hand controller configured to enable the rider to control one or more operations of the device. The hand controller comprises a graphical user interface. The graphical user interface including a display screen configured to present operational information. The operational information includes, but not limited to speed, temperature, and battery level. The hand controller further comprises a mechanical throttle position sensor. The mechanical throttle position sensor is configured to detect rider input for controlling a speed of the device.

The hand controller further comprises one or more buttons. The buttons are configured to allow the rider to shift between a plurality of virtual gears. The hand controller further comprises a haptic feedback module. The haptic feedback module is configured to provide tactile alerts and feedback regarding the operation of the transportation device. The hand controller further comprises a wireless charging circuitry. The wireless charging circuitry is utilized for charging the hand controller without physical connectors. The hand controller comprises one or more external communication ports. The external communication ports are configured to enable peripheral connectivity and data exchange with external systems. In one embodiment, the hand controller comprises a joystick. The joystick is configured to control at least one of a steering and throttle of the transportation device.

The device further comprises a system control unit and a battery system. The battery system is connected to the drivetrain assembly to supply power to one or more motor assemblies. The device further comprises an electronic speed controller (ESC), and a battery management system (BMS). The electronic speed controller (ESC) is electrically connected between the battery system and the electric motors, and in communication with the system control unit. The ESC is configured to receive control signals and regulate motor speed by varying power from the battery system. The battery management system (BMS) is operatively connected to the battery system and system control unit. The BMS is configured to monitor battery parameters and communicate the battery parameters to the system control unit.

The device further comprises a mobile device, a wireless communication system, and the hand controller are in communication with the system control unit. The mobile device is configured to enable the rider to control one or more operations of the device. The wireless communication is configured to provide bidirectional communication between the system control unit and at least one of the hand controllers and the mobile device. The wireless communication system is further configured to provide bidirectional communication between the system control unit and a cloud system. The wireless communication system comprises a GPS communication unit configured to provide geo-location tracking of the device.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates a perspective view of a personal transportation device, according to the embodiment of the present invention.

FIG. 2 exemplarily illustrates another perspective view of the personal transportation device, according to the embodiment of the present invention.

FIG. 3 exemplarily illustrates a perspective view of a propulsion assembly, according to an embodiment of the present invention.

FIG. 4 exemplarily illustrates an axle assembly connected to a drivetrain assembly and a side plate of the propulsion assembly, according to an embodiment of the present invention.

FIG. 5 exemplarily illustrates a perceptive view of an endless drive unit of the propulsion assembly, according to an embodiment of the present invention.

FIG. 6 exemplarily illustrates a side view of a suspension system of the propulsion assembly, according to an embodiment of the present invention.

FIG. 7 exemplarily illustrates another side view of the suspension system of the propulsion assembly, according to an embodiment of the present invention.

FIG. 8 illustrates a flowchart of an operation of the suspension system in the propulsion assembly, according to an embodiment of the present invention.

FIG. 9 exemplarily illustrates the axle assembly connected to the drivetrain assembly, the side plate, and the suspension system, according to an embodiment of the present invention.

FIG. 10 illustrates a flowchart of a mechanical operation of the propulsion assembly, according to an embodiment of the present invention.

FIG. 11 exemplarily illustrates a controller device of the personal transportation device, according to an embodiment of the present invention.

FIG. 12 exemplarily illustrates the hand control of the personal transportation device, according to another embodiment of the present invention.

FIG. 13 exemplarily illustrates a side view of the personal transportation device, according to another embodiment of the present invention.

FIG. 14 exemplarily illustrates an isometric view of the personal transportation device, according to another embodiment of the present invention.

FIG. 15 exemplarily illustrates a rear view of the personal transportation device, according to another embodiment of the present invention.

FIG. 16 exemplarily illustrates an environment of a system to control the personal transportation device, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

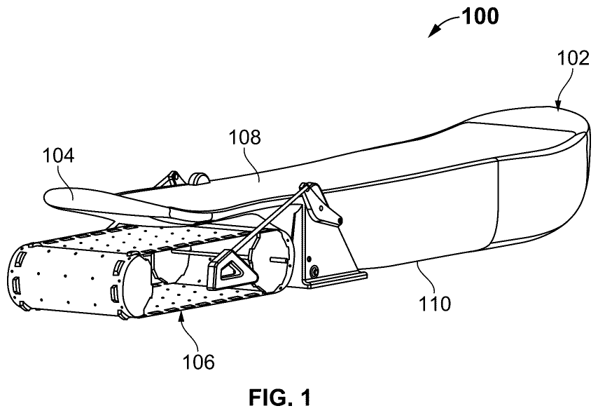

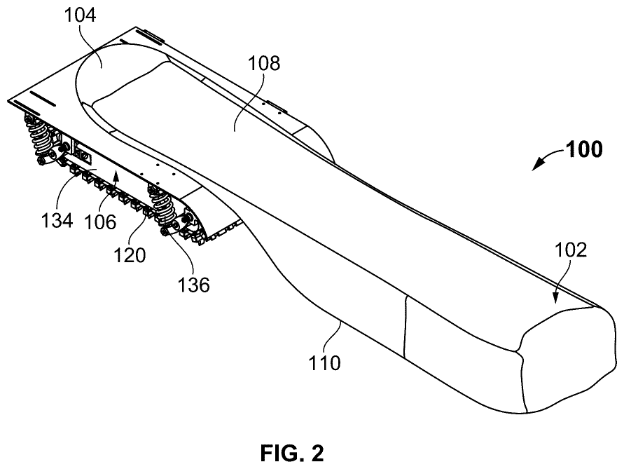

FIG. 1 and FIG. 2 illustrate different views of a personal transportation device 100, according to the embodiment of the present invention. The personal transportation device 100 comprises a frame structure 102, a board platform 104, and a propulsion assembly 106. The frame structure 102 comprises an upper portion 108 and a lower portion 110. The upper portion 108 is connected to the lower portion 110 by internal supports and covered in a fiberglass material. The board platform 104 is mounted to the upper portion 108 of the frame structure 102. The board platform 104 is configured to support a standing rider. The propulsion assembly 106 mounted to the lower portion 110 of the frame structure 102. The frame structure 102 further comprises a front end portion and a back end portion.

The front end portion of the frame structure 102 facilitates gliding smoothly over the ground. The back end portion provides stability for a comfortable ride as the rider shifts weight towards the front end portion of the frame structure 102. Further, the frame structure 102 provides more lift and support while riding to the riders. Further, the raised frame structure 102 at the end of the board platform 104 enables smooth gliding on snow or icy surfaces. The raised frame structure 102 at the end of the board platform 104 maintains the appearance and feel of a traditional non-motorized snowboard.

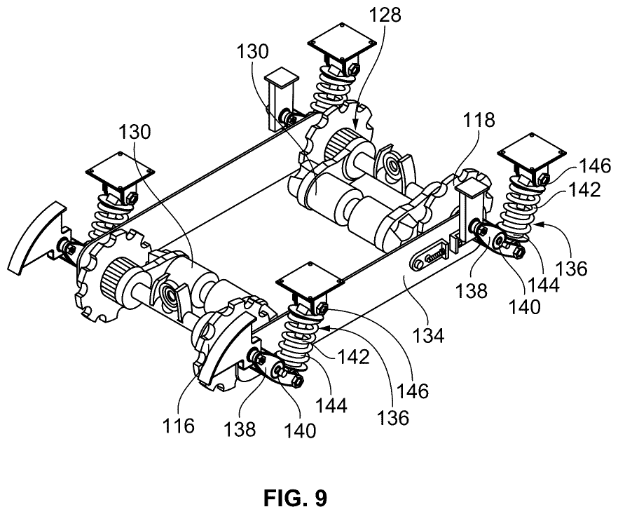

Referring to FIG. 1 to FIG. 4, and FIG. 9, the propulsion assembly 106 comprises an axle assembly coupled to the frame structure 102 comprising a first axle 112 and a second axle 114. The second axle 114 comprises a degree of freedom along the axis of motion. Further, the second axle 114 enables the movement along the axis of motion. The propulsion assembly 106 further comprises a first wheel assembly 116 and a second wheel assembly 118. The first wheel assembly 116 comprises at least two wheels mounted at opposing ends of the first axle 112. The second wheel assembly 118 comprises at least two wheels mounted at opposing ends of the second axle 114. The second wheel assembly 118 is positioned opposite the first wheel assembly 116.

Referring to FIG. 1 to FIG. 5, and FIG. 9, the propulsion assembly 106 comprises at least one endless drive unit operatively engaged with the wheels. The endless drive unit is a belt assembly 120. For example, the belt assembly 120 could be a traction belt system. The first wheel assembly 116 and the second wheel assembly 118 are referred as wheels (116, 118). The continuous drive unit is configured to rotate in response to the rotation of the wheels (116, 118), thereby providing propulsion to the device 100. Further, at least one endless drive unit operatively engaged with one wheel of the first axle 112 and the corresponding wheel of the second axle 114, and at least one endless drive unit operatively engaged with the other wheel of the first axle 112 and the other corresponding wheel of the second axle 114.

In one embodiment, the endless drive unit comprises a pair of side rails 122 and a plurality of transverse crossbars 124 extending between the side rails 122. The crossbars 124 are configured to engage with wheels (116, 118) and provide ground traction during propulsion. The crossbars 124 comprise a plurality of spaced apart wedges 126 extending a portion of the surface of the crossbar 124 engaging the ground. Further, the wedges 126 are configured to propel the board platform 104 forward. The endless drive unit is configured to lock the gear wheels of the drivetrain assembly 128 enables to drive the device 100. Further, different versions of the endless drive unit are utilized to handle different terrains. For example, the endless drive unit that is suitable for summer could be used on grass, sand, dirt, or mixed terrain. The belt assembly 120 having the wedges 126 is suitable for packed snow and makes contact with the ground to enable propulsion of the board platform 104.

In one embodiment, the endless drive unit is configured to extend along at least a portion of the lower portion 110 of the frame structure 102. The endless drive unit is configured to provide the rotational propulsion of the device 100. Further, the frame structure 102 is an unibody type design that allows the riders to comfortably stand and shift weight between from the back end portion of the board platform 104 to the front end portion of the board platform 104. In one embodiment, the front end portion of the board platform 104 makes contact with the ground facilitates turning, and enhances the overall experience by closely mimicking the feel of the traditional snowboard.

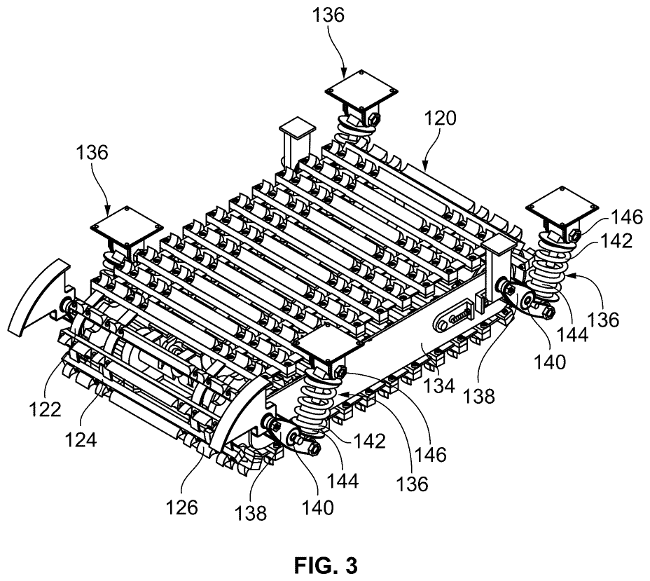

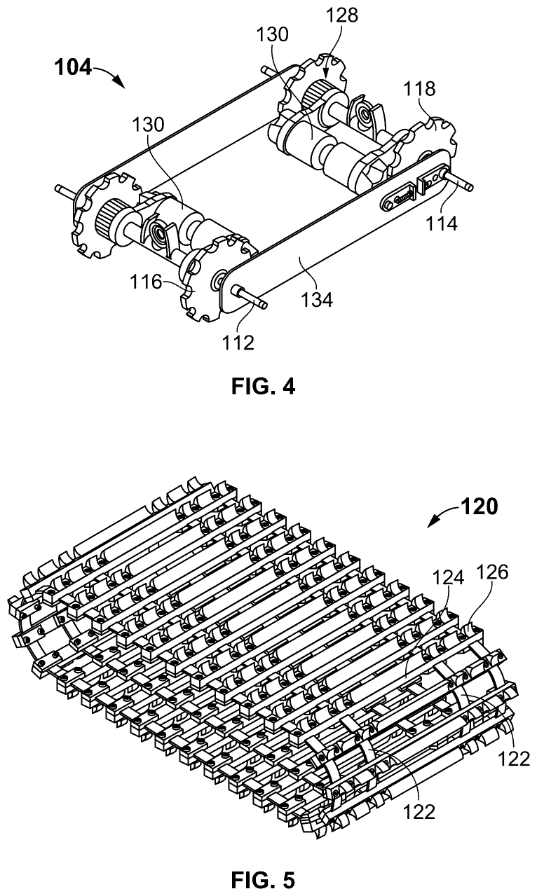

Referring to FIG. 3, FIG. 4, and FIG. 9, the propulsion assembly 106 further comprises the drivetrain assembly 128 coupled to the axle assembly comprising one or more motor assemblies 130. The axle assembly is the mechanical structure that is configured to rigidly hold the drivetrain assembly 128. Each motor assembly 130 is operatively coupled to one or more wheels (116, 118) is configured to transfer rotational energy to the first wheel assembly 116 and second wheel assembly 118. The motor assembly 130 is configured to provide propulsion to the endless drive unit. The motor assembly 130 is configured to provide the power that is the necessary force to drive the endless drive unit. The motor assembly 130 is provided a power source via a battery pack. For example, the battery pack could be a lithium battery pack. The motor assembly 130 comprises an electric motor and the wheels are gear wheels. The electric motor is coupled to the respective gear wheel through a drive system and configured to transfer torque from a respective motor shaft to the respective wheel. The drive system comprises at least one of a drive belt and a gear assembly. The drive belt is a motor belt system 132. In one embodiment, the electric motor is coupled to the respective gear wheel through the drive belt connected to a gear that is operatively connected to a wheel hub of the gear wheel. Referring to FIG. 2 to FIG. 4, and FIG. 9, the frame structure 102 further comprises at least two side plates 134. The first axle 112 and the second axle 114 are arranged between the side plates 134. The side plates 134 are configured to provide support and stability to the propulsion assembly 106.

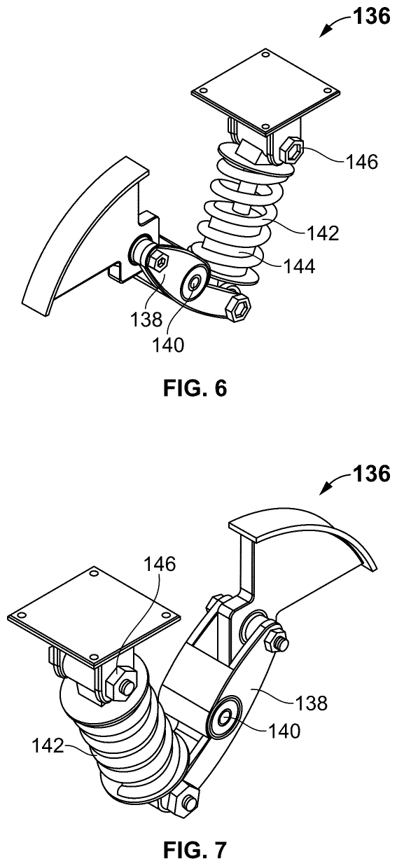

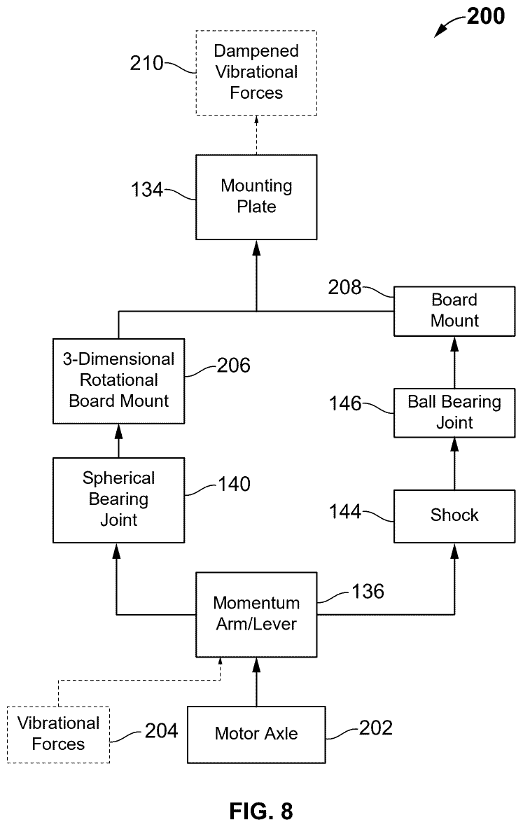

Referring to FIG. 2, FIG. 3, FIG. 6 to FIG. 9, exemplarily illustrate a different view of a suspension system of the frame structure 102 as illustrated a flowchart 200. The propulsion assembly 106 further comprises the suspension system coupled to the drivetrain assembly 128 and the axle assembly. The suspension system comprises one or more suspension assemblies 136. Each suspension assembly 136 is operatively connected between the frame structure 102 and one or more wheels (116, 118) to allow multidimensional articulation and vibration damping. The suspension system is configured to absorb vibrations and enable three-dimensional movement of the wheels (116, 118) relative to the frame structure 102. The suspension assembly 136 is configured to enable independent movement along various axes of the frame structure 102.

The suspension assembly 136 comprises a rotating mounting point, a lever arm 138, a three-dimensional rotational board mount 206, and a board mount 208. The lever arm 138 connects to the rotating mounting point at one end. Further, the lever arm 138 is connected to a coil spring 142 of a shock absorber 144 and the board mount 208 on another end. Further, the shock absorber 144 is connected to the side plate 134 via a spherical bearing joint 140. The spherical bearing joint 140 connects the shock absorber 144 to the side plate 134, which allows for three-dimensional movement and articulation. At least one shock absorber 144 is disposed at each gear wheel connected to the belt assembly 120. Further, the motor axle 202 is connected to the lever arm 138. Further, the lever arm 138 is mounted directly to the board mount 208 of the axle assembly with a ball bearing joint 146. The suspension assembly 136 is specially engineered to emulate the experience of the traditional snowboard through the device 100 allows for multiple degrees of freedom by using the rotating mounting points.

The suspension assembly 136 is configured to ensure smooth handling and control while riding the frame structure 102. The suspension assembly 136 is further configured to enable independent movement along various axes of the board platform 104. The dampened vibrational force 210 is a subset of vibrational force 204, which is applied to resist the motion of the system. Further, the suspension assembly 136 to transmits minor vibrations to the rider for a more responsive rider experience larger vibrations are absorbed and dampened by the shock absorbers 144 to maintain smooth operation.

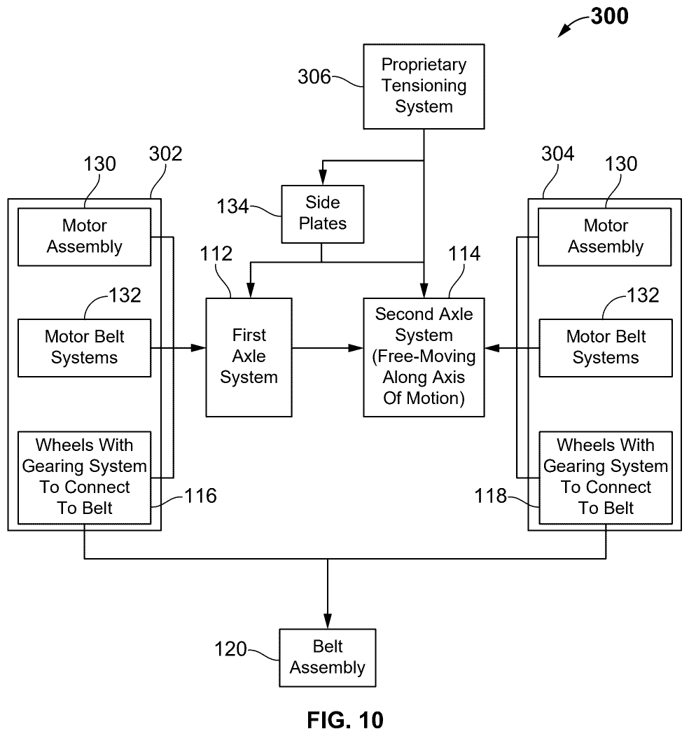

Referring to FIG. 10, a flowchart 300 illustrates the mechanical operation of propulsion assembly 106. The first axle 112 connected to the motor assembly 130 and the gear wheels disposed at the front end portion of lower portion 110 of the frame structure 102, represented as 302. Further, the second axle 114 connected to the motor assembly 130 and the gear wheels disposed at the back end portion of the lower portion 110 of the frame structure 102, represented as 304. Further, the side plate 134 connects to the motor assembly 130 and the gear wheel of the first axle 112 and second axle 114 respectively. The second axle 114 further enables the movement along the axis of motion. The device 100 further comprises a tensioning system 306 coupled to the axle assembly. The tensioning system 306 is configured to adjust the spacing between the first wheel assembly 116 and the second wheel assembly 118 to control the tension of the endless drive unit. The device 100 further comprises a lighting system configured to provide illumination and visual feedback. The lighting system comprises one or more headlights, taillights, and body lights arranged on the frame structure 102. The lightening system further comprises a control circuit. Further, the control circuit is configured to regulate the power to the lighting components and control lighting behavior based on the operating conditions of the device 100.

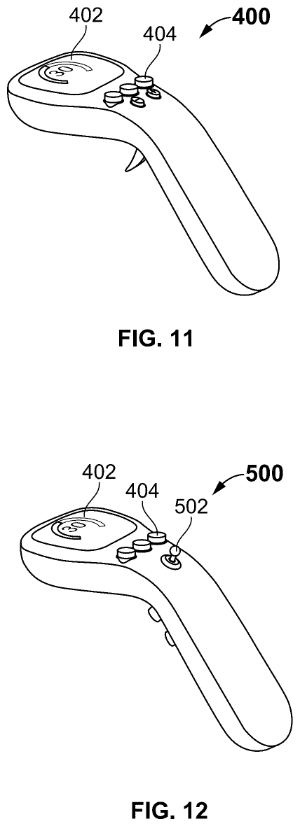

Referring to FIG. 11 and FIG. 12, the device 100 further comprises a hand controller (400, 500). The hand controller (400, 500) is configured to enable the rider to control one or more operations of the device 100. The hand controller (400, 500) comprises a graphical user interface 402. The graphical user interface 402 includes a display screen configured to present operational information. The operational information includes, but not limited to, speed, temperature, and battery level. The hand controller (400, 500) further comprises a mechanical throttle position sensor. The mechanical throttle position sensor is configured to detect rider input for controlling the speed of the device (100, 600).

The hand controller (400, 500) further comprises one or more buttons 404. The buttons 404 are configured to allow the rider to shift between a plurality of virtual gears. The hand controller (400, 500) further comprises a haptic feedback module. The haptic feedback module is configured to provide tactile alerts and feedback regarding the operation of the transportation device (100, 600). The hand controller (400, 500) further comprises a wireless charging circuitry. The wireless charging circuitry is utilized for charging the hand controller (400, 500) without physical connectors. The hand controller (400, 500) comprises one or more external communication ports. The external communication ports are configured to enable peripheral connectivity and data exchange with external systems. The hand controller (400, 500) enables the rider to adjust the tension of the endless drive unit as required by manipulating the tensioning system 306. The hand controller 400 is configured to operate and control a single belt assembly 120 attached frame structure 102. Referring to FIG. 12, in one embodiment, the hand controller 500 comprises a joystick 502. The joystick 502 is configured to control at least one of a steering and throttle of the transportation device 600.

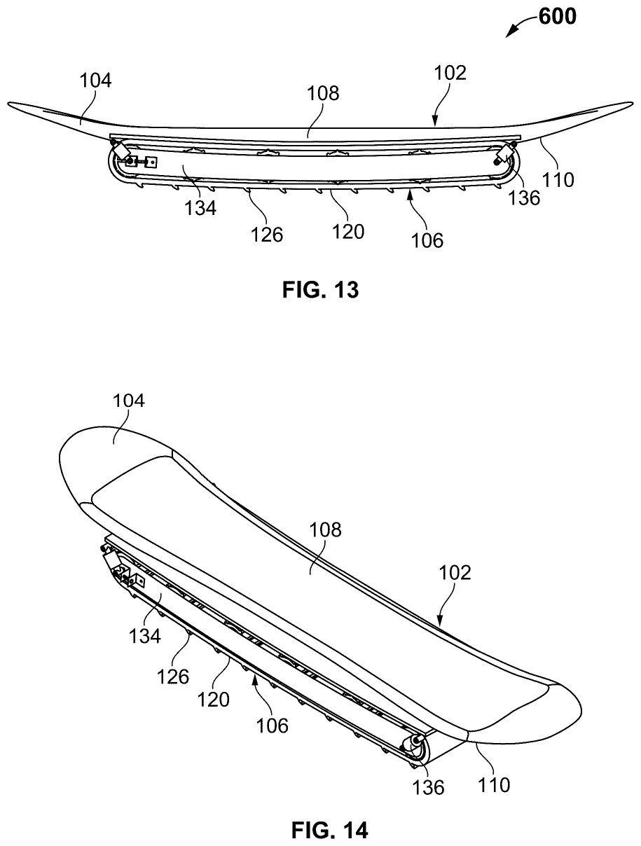

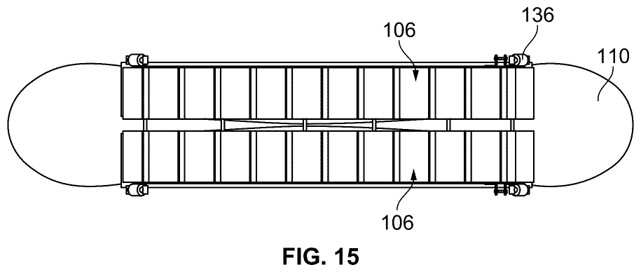

FIG. 13 to FIG. 15 exemplarily illustrates a different view of the propulsion assembly 106 the personal transportation device 600, according to another embodiment of the present invention. The personal transportation device 600 comprises the frame structure 102, the board platform 104, and the propulsion assembly 106. The frame structure 102 comprises the upper portion 108 and the lower portion 110. The propulsion assembly 106 further comprises the axle assembly, the first wheel assembly 116, the second wheel assembly 118, the drivetrain assembly 128, the endless drive unit, the suspension assembly 136, and the side plates 134. The frame structure 102 comprises at least propulsion assembly 106 mounted to the lower portion 110 of the frame structure 102. The propulsion assembly 106 comprising the endless drive unit is configured to extend along a length of the lower portion 110 of the frame structure 102. The personal transportation device 600 is a dual belt assembly 120 attached frame structure 102. Further, the personal transportation device 600 is operated to control the steering and throttle using the hand controller 500 comprising the joystick 502 and the buttons 404. The joystick is configured to control the steering and throttle. The button 404 is configured to control the virtual gears. The hand controller 500 is configured to turn the device 600 using a turning control that operates in conjunction with a throttle control. Further, the device 600 is able to turn in required directions by operating one endless drive unit at a slower speed than the other endless drive unit.

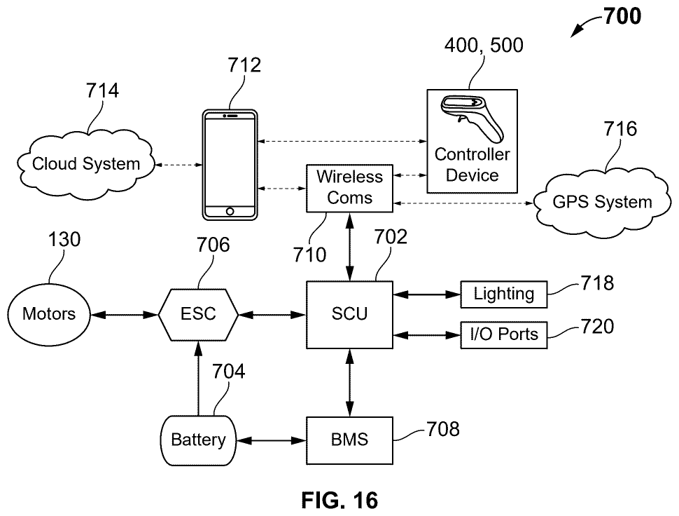

FIG. 16 exemplarily illustrates an environment 700 of a system to control the device (100, 600). The device (100, 600) further comprises a system control unit 702, and a battery system 704. The battery system 704 is connected to the drivetrain assembly 128 to supply power to one or more motor assemblies 130. The battery system 704 of the device (100, 600) is configured to be a compact, lightweight, safe, and easily manageable. Further, the battery system 704 is configured to supply power to all electronic components within the device (100, 600). The device (100, 600) further comprises an electronic speed controller (ESC) 706, and a battery management system (BMS) 708. The electronic speed controller (ESC) 706 is electrically connected between the battery system 704 and the electric motors, and is in communication with the system control unit 702. The ESC 706 is configured to receive control signals and regulate electric motor speed by varying power from the battery system 704. The electronic speed controller (ESC) 706 is configured to enable to send speed control commands from the controller device (400, 500). The ESC 706 further translates the commands to device (100, 600) to increase or decrease the supply of the power source to the electric motor. Further, the ESC 706 controls the speed and direction of the device (100, 600).

The battery management system (BMS) 708 is operatively connected to the battery system 704 and system control unit 702. The BMS 708 is configured to monitor battery parameters and communicate the battery parameters to the system control unit 702. The battery management system (BMS) 708 is configured to manage all operations and data reporting of the main battery system 704. Further, the battery management system (BMS) 708 is configured to ensure the operation of the battery system 704 within a safe range of parameters and provide data back to the system control unit 702. The BMS 708 is also configured to manage the recharging of the main battery. The battery system 704 further comprises a safety mechanism to mitigate problems, for example, over-current and over temperature. The safety mechanisms include software and hardware safety checks performed by the BMS 708. The battery system 704 comprises a ventilation, heat dissipation design, and built-in safety fusing. Further, the control circuit of the lightning 718 is operatively connected to the system control unit 702. Further, the control circuit connected to the system control unit 702 is configured to regulate the power to the lighting 718 components and control lighting behavior based on the operating conditions of the device (100, 600).

The device (100, 600) further comprises a wireless communication system 710, a mobile device 712, and the hand controller (400, 500) are in communication with the system control unit 702. The mobile device 712 is configured to enable the rider to control one or more operations of the device (100, 600). The wireless communication system 710 is configured to provide bidirectional communication between the system control unit 702 and at least one of the hand controllers (400, 500) and the mobile device 712. The wireless communication system 710 is further configured to provide bidirectional communication between the system control unit 702 and a cloud system 714. The wireless communication system 710 comprises a Global Positioning System (GPS) communication unit 716 is configured to provide geo-location tracking of the device (100, 600). The wireless communication system 710 is configured to enable a reliable and durable communication link of the wireless devices throughout the operation of the device (100, 600). The system control unit 702 is further configured to activate the lighting 718 and control lighting modes in response to the rider input or preprogrammed conditions. The system control unit 702 is further configured to manage the external communication ports and data exchange with external systems. The port could be an input port or an output port 720.

Advantageously, the device (100, 600) allows the rider to control the speed via the hand controller (400, 500) while riding the device (100, 600). Further, the device (100, 600) enables easy speed adjustment and directional control by independently altering the speed of each belt assembly 120. Further, the device (100, 600) enables the user to shift weight comfortably during the ride without affecting the snowboarding experience. The raised frame structure 102 of upper portion 108 is configured to allow the rider to direct and steer the board platform 104 by angling, leaning, and the lower portion 110 of the frame structure 102 is configured pivoting as the wedges 126 catch the snow on the ground. Further, the device (100, 600) is driven by battery-powered motors and the traction belt system. The hand controller (400, 500) is configured to provide the rider with information including speed, and battery status. Additionally, the hand controller 500 is configured to provide steering capability.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A personal transportation device, comprising:
a frame structure;
a board platform mounted to an upper portion of the frame structure, the board platform configured to support a standing rider, and
a propulsion assembly mounted to a lower portion of the frame structure, the propulsion assembly comprising:
an axle assembly coupled to the frame comprising a first axle and a second axle positioned opposite to the first axle,
a first wheel assembly comprising at least two wheels mounted at opposing ends of the first axle,
a second wheel assembly comprising at least two wheels mounted at opposing ends of the second axle, the second wheel assembly being positioned opposite the first wheel assembly,
at least one endless drive unit operatively engaged with the wheels, wherein the continuous drive unit is configured to rotate in response to the rotation of the wheels, thereby providing propulsion to the device,
a drivetrain assembly coupled to the axle assembly comprising one or more motor assemblies, each motor assembly is operatively coupled to one or more wheels to transfer rotational energy to the first wheel assembly and second wheel assembly, and
a suspension system coupled to the drivetrain assembly and axle assembly, wherein the suspension system comprises one or more suspension assemblies, each suspension assembly operatively connected between the frame and one or more wheels to allow multidimensional articulation and vibration damping.

2. The device of claim 1, wherein the frame comprises at least two side plates, wherein the first axle and the second axle are arranged between the side plates.

3. The device of claim 1, wherein the endless drive unit is configured to extend along at least a portion of the lower portion of the frame.

4. The device of claim 1, wherein the endless drive unit is configured to extend along a length of the lower portion of the frame.

5. The device of claim 1, wherein at least one endless drive unit operatively engaged with one wheel of the first axle and the corresponding wheel of the second axle, and at least one endless drive unit operatively engaged with the other wheel of the first axle and the other corresponding wheel of the second axle.

6. The device of claim 1, wherein the endless drive unit comprises a pair of side rails and a plurality of transverse crossbars extending between the side rails, wherein the crossbars are configured to engage with wheels and provide ground traction during propulsion, wherein the crossbars comprise a plurality of spaced apart wedges extending a portion of the surface of the crossbar engaging the ground.

7. The device of claim 1, further comprises a tensioning system coupled to the axle assembly, wherein the tensioning system is configured to adjust the spacing between the first wheel assembly and second wheel assembly to control the tension of the endless drive unit.

8. The device of claim 1, wherein the motor assembly comprises an electric motor, wherein the wheels are gear wheels.

9. The device of claim 8, wherein the electric motor is coupled to the respective gear wheel through a drive system and configured to transfer torque from a respective motor shaft to the respective wheel, wherein the drive system comprises at least one of a drive belt and gear assembly.

10. The device of claim 8, wherein the electric motor is coupled to the respective gear wheel through a drive belt connected to a gear that is operatively connected to a wheel hub of the gear wheel.

11. The device of claim 1, further comprises:
a system control unit;
a battery system connected to the drivetrain assembly to supply power to one or more motor assemblies;
an electronic speed controller (ESC) is electrically connected between the battery system and the electric motors, and in communication with the system control unit, wherein the ESC is configured to receive control signals and regulate motor speed by varying power from the battery system, and
a battery management system (BMS) is operatively connected to the battery system and system control unit, wherein the BMS is configured to monitor battery parameters and communicate the battery parameters to the system control unit.

12. The device of claim 11, further comprises:
a hand controller in communication with the system control unit configured to enable the rider to control one or more operations of the device,
a mobile device in communication with the system control unit configured to enable the rider to control one or more operations of the device, and
a wireless communication system in communication with the system control unit configured to provide bidirectional communication between the system control unit and at least one of: a hand controller and a mobile device, wherein the wireless communication system is further configured to provide bidirectional communication between the system control unit and a cloud system.

13. The device of claim 12, wherein the wireless communication system comprises a GPS communication unit configured to provide geo-location tracking of the device.

14. The device of claim 12, wherein the hand controller comprises:
a graphical user interface including a display screen configured to present operational information including speed, temperature, and battery level;
a mechanical throttle position sensor configured to detect user input for controlling a speed of the device;
one or more buttons configured to allow the rider to shift between a plurality of virtual gears;
a haptic feedback module configured to provide tactile alerts and feedback regarding the operation of the transportation device;
a wireless charging circuitry for charging the hand controller without physical connectors, and
one or more external communication ports for peripheral connectivity and data exchange with external systems.

15. The device of claim 14, wherein the hand controller comprises a joystick configured to control at least one of a steering and throttle of the transportation device.

16. The device of claim 1, wherein the suspension assembly is configured to absorb vibrations and enable three-dimensional movement of the wheel assembly relative to the frame structure.

17. The device of claim 1, further comprising a lighting system configured to provide illumination and visual feedback, the lighting system comprising:
one or more headlights, taillights, and body lights arranged on the frame structure, and
a control circuit is operatively connected to the system control unit, the control circuit is configured to regulate the power to the lighting components and control lighting behavior based on the operating conditions of the device,
wherein the system control unit is further configured to activate the lighting system and control lighting modes in response to user input or preprogrammed conditions.
